(19) United States
(12) Patent Application Publication
(10) Pub. No.: US 2017/0126037 A1
(43) Pub. Date: May 4, 2017

(54) MULTIFUNCTIONAL MOBILE STATION

(71) Applicant: INDUSTRIAL BANK OF KOREA, Seoul (KR)

(72) Inventors: Pilsoon SHIN, Busan (KR); Jongman KWON, Gwangju-si (KR)

(21) Appl. No.: 14/927,168

(22) Filed: Oct. 29, 2015

(51) Int. Cl. H02J 7/00; H05B 33/08; H02J 7/02; H04W 4/00

(52) U.S. Cl. CPC H02J 7/0042; H04W 4/008; H05B 33/0845; H02J 7/0054; H02J 7/025; H02J 2007/0062

(57) ABSTRACT

The present invention provides a portable multifunctional mobile station. The portable multifunctional mobile station includes a battery, a main body that accommodates the battery therein, an accommodation unit that is provided on one side of the main body and accommodates a mobile terminal device, a wireless power transmission unit that is supplied with power from the battery and transmits wireless power to the mobile terminal device accommodated in the accommodation unit, a short-range wireless communication unit that performs short-range wireless communication with the mobile terminal device accommodated in the accommodation unit, a control unit that processes sound signals transmitted from the mobile terminal device by the short-range wireless communication unit to reproduce the sound signals and controls an operation of the wireless power transmission unit, and a speaker that outputs the sound signals processed by the control unit to the outside.

### BACKGROUND

1. Field of the Invention

The present invention relates to a portable multifunctional mobile station.

2. Discussion of Related Art

In recent years, a variety of portable media devices having a sound output function or an image output function have been launched. Such a portable media device is a device that is manufactured to record or reproduce sound signals or image signals in the form of digital files, and as representative examples thereof, an MP3 player, a portable phone (e.g., smart phone), a portable multimedia player (PMP), and the like may be given.

The portable media device having a sound signal reproducing function stores the sound signals in the form of digital files in a semiconductor memory, and thereby a large amount of digital files may be stored in a relatively small-sized device. Thus, a user may conveniently use the portable media device while carrying the same. When using the portable media device while carrying the same, a user usually listens to the sound signals reproduced through an earphone or a headphone.

The sound quality of the sound signals reproduced by such a portable media device are not good relative to the sound quality of sound signals reproduced by a high-quality audio device, and therefore there has been a demand from users who desire to listen to the sound reproduced by a better audio system when they use the portable media device in the room without carrying the same.

To meet the need from the users, a docking station in which the portable media device is mounted to reproduce sound signals has been developed and released. The docking station refers to a device that is coupled to the portable media device via a docking terminal so that a user can enjoy a sound source stored in a memory even in a wide space such as a living room.

However, in recent years, according to the rapid development of the outdoor culture such as camping, hiking, and the like, a docking station to reproduce a better audio system outdoors as well as indoors has been desperately needed.

A conventional docking station does not include a separate power source therein so it cannot be carried, and when a docking terminal provided in the docking station is not compatible with a portable media device, there is a problem in that the portable media device cannot be charged or a sound source stored in the portable media device cannot be reproduced, and there is also a problem in that a plurality of portable media devices cannot be simultaneously charged.

The following Korea Patent Publication No. 10-2009-0097619 discloses a docking station including a station speaker that receives sound signals from a mono-headset and outputs the received sound signals when the mono-headset is docked in a docking unit, but when the mono-headset is docked in the docking station, only one mono-headset may be charged and thereby a plurality of portable media devices cannot be simultaneously charged.

### SUMMARY OF THE INVENTION

The present invention is directed to a portable multifunctional mobile station which may include a battery capable of providing power so it can be carried and provide wireless power transmission and short-range wireless communication functions, and thereby it can charge a mobile terminal device regardless of a type of the mobile terminal device and reproduce a sound source stored in the mobile terminal device.

The present invention is also directed to a portable multifunctional mobile station which may include one or more docking terminals or one or more USB terminals, and thereby it can simultaneously charge a plurality of mobile terminal devices.

Ultimately, the present invention is also directed to a portable multifunctional mobile station which may reproduce multimedia that can be reproduced in a mobile terminal device such as sound source data, video data, and the like from a specific mobile terminal device while charging a plurality of mobile terminal devices.

According to an aspect of the present invention, there is provided a portable multifunctional mobile station including a battery, a main body that accommodates the battery therein, an accommodation unit that is provided on one side of the main body, and accommodates a mobile terminal device, a wireless power transmission unit that is supplied with power from the battery, and transmits wireless power to the mobile terminal device accommodated in the accommodation unit, a short-range wireless communication unit that performs short-range wireless communication with the mobile terminal device accommodated in the accommodation unit, a control unit that processes sound signals transmitted from the mobile terminal device by the short-range wireless communication unit so as to reproduce the sound signals, and controls an operation of the wireless power transmission unit, and a speaker that outputs the sound signals processed by the control unit to the outside.

Here, the portable multifunctional mobile station may further include an input unit that receives an input of a sound signal reproducing operation of the mobile terminal device, wherein the control unit controls the mobile terminal device through the short-range wireless communication unit according to an input signal provided from the input unit.

Also, the battery may be any one of a lithium polymer battery or a lithium iron phosphate battery.

Also, the portable multifunctional mobile station may further include one or more universal serial bus (USB) terminals which are provided on one side of the main body, and are electrically connected to the control unit and the battery.

Also, the portable multifunctional mobile station may further include one or more docking terminals which are provided inside the accommodation unit, and are configured to transmit power between the mobile terminal device and the battery and provide data communication between the mobile terminal device and the control unit.

Also, the portable multifunctional mobile station may further include a rapid charging input unit that rapidly charges the mobile terminal device, wherein the control unit rapidly charges the mobile terminal device using the docking terminal and the wireless power transmission unit, when receiving a rapid charging signal from the rapid charging input unit.

Also, the main body may be subjected to a waterproof treatment to prevent water from flowing into the main body.

Also, the portable multifunctional mobile station may further include a storage unit that is provided on one side of the main body to make possible storage and retrieval of a stored cable or peripheral device of the mobile terminal device.

Also, the portable multifunctional mobile station may further include one or more light emitting diode (LED) lighting units which are provided on one side of the main body, and a lighting input unit that receives ON/OFF inputs provided by the LED lighting unit.

Also, the portable multifunctional mobile station may further include an outlet connector that is provided on one side of the main body, and configured to provide power of the battery to an external device.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a perspective view illustrating the external appearance of a portable docking station according to an embodiment of the present invention;

FIG. 2 is a block diagram illustrating a portable docking station according to an embodiment of the present invention; and

FIG. 3 is a block diagram illustrating a portable docking station according to another embodiment of the present invention.

### DETAILED DESCRIPTION OF EXEMPLARY EMBODIMENTS

Hereinafter, preferred embodiments according to the present invention will be described with reference to the accompanying drawings.

However, the embodiments of the present invention can be modified in many different forms and the scope of the present invention is not limited to the embodiments described below. In addition, the embodiments of the present invention are provided to more completely explain the present invention to those skilled in the art.

In the specification and the drawings, the same reference numerals will be given to the components having substantially the same functional configurations, and the repetitive description thereof will be omitted, and the shape, size, etc. of the components shown in the drawings may be exaggerated for more clear explanation.

In the following descriptions of possible embodiments operable from the invention, when some of the components and features of the present invention are known and description thereof obscures the subject matter of the present invention, the corresponding detailed description will be omitted, and a specific embodiment illustrated in the drawings will be mainly described.

However, this is not intended to limit the invention to the specific embodiments, it is to be understood to include all modifications, equivalents, and substitutes included in the spirit and scope of the present invention.

In the specifications, it should be understood that the terms “comprising,” or “including” when used in these specifications, specify the presence of stated features, attributes, compositions, and components, but do not preclude the presence or addition of one or more other features, attributes, compositions, components, and a combination thereof. In the specifications, the terms “exemplary” means “serving as an example, an instance, or an illustration”, and any implementation described as exemplary or illustrative is not meant to be construed as preferred or advantageous over other implementations. In addition, as used herein, the singular forms “a,” “an,” and “the” are intended to include the plural forms, including “at least one,” unless the content clearly indicates otherwise.

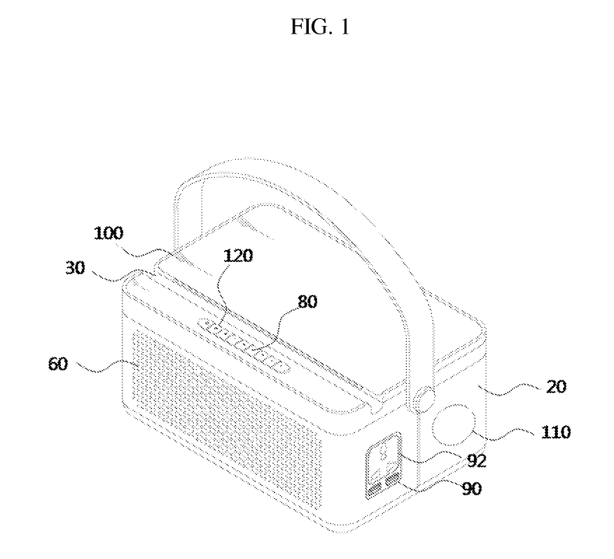

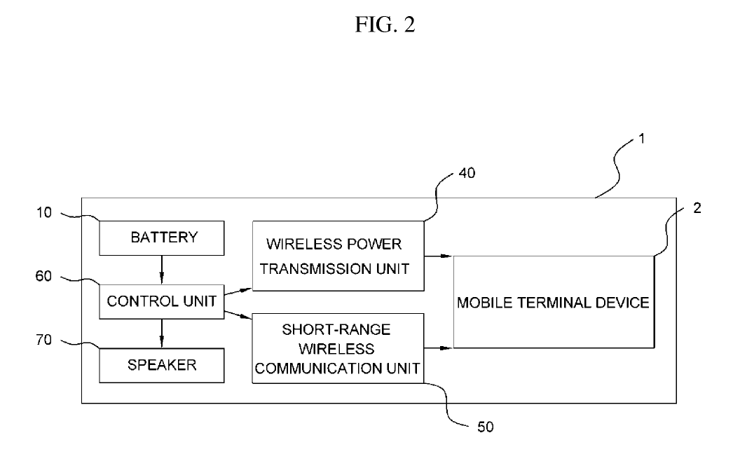

FIG. 1 is a perspective view illustrating the external appearance of a portable docking station according to an embodiment of the present invention, and FIG. 2 is a block diagram illustrating a portable docking station according to an embodiment of the present invention.

Referring to FIGS. 1 and 2, a portable multifunctional mobile station 1 according to an embodiment of the present invention may include a battery 10, a main body 20, an accommodation unit 30, a wireless power transmission unit 40, a short-range wireless communication unit 50, a control unit 60, and a speaker 70.

The battery 10 may be accommodated into the main body 20, and provide power to the wireless power transmission unit 40 by the control of the control unit 60. According to an embodiment, the battery 10 may be any one of a lithium polymer battery or a lithium iron phosphate battery. Here, the battery 10 may be charged by an external power source.

The main body 20 may form the external appearance of the portable multifunctional mobile station 1. On an upper side of the main body 20, the accommodation unit 30 on which a mobile terminal device 2 is placed, an input unit 80 that receives an input of a sound signal reproducing operation, a lighting input unit 120, and a storage unit 100 that is provided so as to allow storage and retrieval of stored cables or peripheral devices of the mobile terminal device 2 may be provided.

The mobile terminal device 2 refers to an electronic communication device enabling data communication and voice communication functions, is technically referred to as a subscriber station, a mobile station, user equipment, a mobile device, or the like, and is collectively referred to as a mobile phone, a cell phone, a smartphone, a tablet PC, a smart device on the market. The cables or the peripheral devices of such a mobile terminal device 2 may refer to universal serial bus (USB) cables for connecting the mobile terminal device 2 with an external device such as a personal computer (PC), earphones, wired charging cables, hands-free or Bluetooth microphone sets, and the like, but are not limited thereto.

In addition, on a front surface of the main body 20, the speaker 70 for outputting sound signals may be arranged. In addition, on a side surface of the main body 20, a plurality of USB terminals 90, an outlet connector 92, and a light emitting diode (LED) lighting unit 110 may be arranged. According to an embodiment, the main body 20 may be subjected to a waterproof treatment so as to prevent water from flowing into the main body 20.

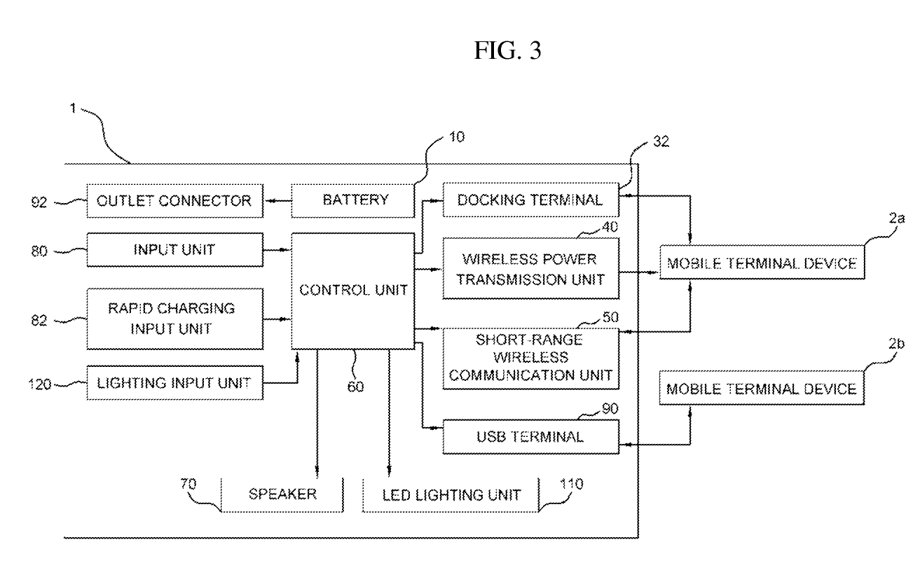

The accommodation unit 30 may be provided on one side of the main body 20 to accommodate the mobile terminal device 2. According to an embodiment, the accommodation unit 30 may support and accommodate the mobile terminal device 2 to maintain a predetermined angle in a state in which the mobile terminal device 2 is erect inside the accommodation unit 30. By the accommodation unit 30 that supports the mobile terminal device 2 in this manner, a user may reproduce video data through a display unit of the mobile terminal device 2 and conveniently enjoy the reproduced video data. According to an embodiment, in the accommodation unit 30, one or more docking terminals (see 32 of FIG. 3) that provides an electrical connection between the mobile terminal device 2 and the control unit 60 may be arranged.

The wireless power transmission unit 40 may be supplied with power from the battery 10 by the control of the control unit 60, and transmit wireless power to the mobile terminal device 2 accommodated in the accommodation unit 30. The wireless power transmission may be achieved by any one method according to wireless power consortium (WPC) using a magnetic induction technique, power matters alliance (PMA), and alliance for wireless power (A4WP) using a magnetic resonance technique.

According to an embodiment, the wireless power transmission unit 40 may include a coil (not shown) that transmits wireless power to the mobile terminal device 2 accommodated in the accommodation unit 30 by generating an electric field or a magnetic field, and a power supply circuit (not shown) that supplies power to the coil by the control of the control unit 60.

The short-range wireless communication unit 50 may perform short-range wireless communication with the mobile terminal device 2 accommodated in the accommodation unit 30. According to an embodiment, the short-range wireless communication unit 50 may relay data communication between the control unit 60 and the mobile terminal device 2 using Bluetooth or near field communication (NFC).

The control unit 60 may control overall operations of the portable multifunctional mobile station 1. The control unit 60 may transmit wireless power to the mobile terminal device 2 accommodated in the accommodation unit 30 by controlling the operation of the wireless power transmission unit 40. In addition, in order to reproduce sound signals transmitted from the mobile terminal device 2 by the short-range wireless communication unit 50, the control unit 60 may process the sound signals, and output the processed sound signals through the speaker 70.

FIG. 3 is a block diagram illustrating a portable docking station according to another embodiment of the present invention.

Referring to FIG. 3, the portable docking station 1 according to another embodiment of the present invention may further include at least one of the input unit 80 that receives an input of a sound signal reproducing operation, the USB terminal 90, a docking terminal 32, a rapid charging input unit 82, the outlet connector 92, the LED lighting unit 110, and the lighting input unit 120.

The input unit 80 may receive an input of signals for controlling the sound signal reproducing operation of the mobile terminal device 2 which is accommodated in the accommodation unit 30 to be connected to the control unit 60 by the short-range wireless communication unit 40, or which is connected to the control unit 60 by the docking terminal 32 or the USB terminal 90. According to an embodiment, the input unit 80 may be arranged on the upper side of the main body 20 as shown in FIG. 1, and include a plurality of buttons which receive the input of the signals controlling the sound signal reproducing operation such as play, stop, search, next song, previous song, volume up, volume down, and the like and output the received signals to the control unit 60.

Here, when receiving the signals from the input unit 80, the control unit 60 may control the mobile terminal device 2 by outputting an operation control signal via a path according to the connection between the control unit 60 and the mobile terminal device 2.

When the USB terminal 90 is electrically connected to the control unit 60 and the battery 10 and a mobile terminal device 2b is connected through the USB terminal 90, the mobile terminal device 2b may be charged, and the control unit 60 may receive the sound signals transmitted from the mobile terminal device 2b, process the sound signals, and output the processed sound signals to the outside through the speaker 70. A plurality of USB terminals 90 may be provided on the side surface of the main body 20.

The docking terminal 32 may be arranged inside the accommodation unit 30, and transmit power between a mobile terminal device 2a and the battery 10 which are connected with the docking terminal 32 and provide data communication between the mobile terminal device 2a and the control unit 60. According to an embodiment, a plurality of docking terminals 32 may be provided, and each of the plurality of docking terminals 32 may be provided in the form capable supporting the sound signal reproducing of the mobile terminal devices 2 belonging to different product groups. For example, any one of the plurality of docking terminals 32 may support an electrical connection of the mobile terminal device belonging to product group A (Apple's portable media device of US), and another of the plurality of docking terminals 32 may support an electrical connection of the mobile terminal device belonging to product group B (portable terminal device for Android such as Samsung's Galaxy).

The rapid charging input unit 82 may supply power using the wireless power transmission unit 40 to the mobile terminal device 2 connected to the docking terminal 32 or the USB terminal 90 while supplying power to the mobile terminal device 2 through the connected terminal, and thereby receive a user input for providing a rapid charging function to the mobile terminal device 2.

The rapid charging input unit 82 may be arranged on the upper surface of the main body 20 together with the input unit 80. Here, when receiving a rapid charging input from the rapid charging input unit 82, the control unit 60 may provide wireless power to the mobile terminal device 2 to which wired power is supplied through the docking terminal 32 or the USB terminal 90, by controlling the wireless power transmission unit 40.

In this manner, the portable multifunctional mobile station 1 according to an embodiment of the present invention may basically charge the mobile terminal device 2 docked by the rapid charging input unit 82 and the wireless power transmission unit 40, and include one or more docking terminals 32 or one or more USB terminals 90 so that the portable multifunctional mobile station 1 according to the present invention may simultaneously charge a large number of allowable mobile terminal devices.

The outlet connector 92 may be arranged on one side of the main body 20, and provide power of the battery 10 to an external electronic device when a commercial power outlet of the external electronic device is inserted into the outlet connector 92.

The LED lighting unit 110 may be arranged on one side of the main body 20, and may be turned ON/OFF according to ON/OFF inputs provided from the lighting input unit 120. A plurality of LED lighting units 110 may be provided, as necessary, and may be respectively arranged on a different side surface of the main body 20.

The portable multifunctional mobile station 1 according to the embodiments of the present may include the battery 10, the main body 20 that accommodates the battery 10 therein, the accommodation unit 30 that is provided on one side of the main body 20 to accommodate a mobile terminal device, the wireless power transmission unit 40 that is supplied with power from the battery and transmits wireless power to the mobile terminal device accommodated in the accommodation unit 30, the short-range wireless communication unit 50 that performs short-range wireless communication with the mobile terminal device accommodated in the accommodation unit 30, the control unit 60 that processes sound signals transmitted from the mobile terminal device by the short-range wireless communication unit 50 in order to reproduce the sound signals and controls an operation of the wireless power transmission unit 40, and the speaker 70 that outputs the sound signals processed by the control unit 60 to the outside.

As described above, the portable multifunctional mobile station according to the embodiments of the present invention may include the battery capable of providing power so it can be carried and provide wireless power transmission and short-range wireless communication functions, and thereby it can charge the mobile terminal device regardless of the type of the mobile terminal device and reproduce a sound source stored in the mobile terminal device.

In addition, the portable multifunctional mobile station according to the embodiments of the present invention may include one or more docking terminals or one or more USB terminals, and thereby it can simultaneously charge a plurality of mobile terminal devices.

In addition, the portable multifunctional mobile station according to the embodiments of the present invention may be utilized in the outdoor environment as a lighting device in case of emergency, and also utilized as a power supply device of an external power device.

It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

What is claimed is:

1. A portable multifunctional mobile station comprising:
a battery;
a main body which accommodates the battery therein;
an accommodation unit which is provided on one side of the main body, and accommodates a mobile terminal device;
a wireless power transmission unit which is supplied with power from the battery, and is configured to transmit wireless power to the mobile terminal device accommodated in the accommodation unit;
a short-range wireless communication unit which performs short-range wireless communication with the mobile terminal device accommodated in the accommodation unit;
a control unit which processes sound signals transmitted from the mobile terminal device by the short-range wireless communication unit to reproduce the sound signals, and controls an operation of the wireless power transmission unit; and
a speaker which outputs the sound signals processed by the control unit to the outside.

2. The portable multifunctional mobile station of claim 1, further comprising:
an input unit which receives an input of a sound signal reproducing operation of the mobile terminal device,
wherein the control unit controls the mobile terminal device through the short-range wireless communication unit according to an input signal provided from the input unit.

3. The portable multifunctional mobile station of claim 1, wherein the battery is any one of a lithium polymer battery or a lithium iron phosphate battery.

4. The portable multifunctional mobile station of claim 1, further comprising:
one or more universal serial bus (USB) terminals which are provided on one side of the main body, and are electrically connected to the control unit and the battery.

5. The portable multifunctional mobile station of claim 1, further comprising:
one or more docking terminals which are provided inside the accommodation unit, and are configured to transmit power between the mobile terminal device and the battery and provide data communication between the mobile terminal device and the control unit.

6. The portable multifunctional mobile station of claim 5, further comprising:
a rapid charging input unit which rapidly charges the mobile terminal device,
wherein the control unit rapidly charges the mobile terminal device using the docking terminal and the wireless power transmission unit, when receiving a rapid charging signal from the rapid charging input unit.

7. The portable multifunctional mobile station of claim 1, wherein the main body is subjected to a waterproof treatment to prevent water from flowing into the main body.

8. The portable multifunctional mobile station of claim 1, further comprising:
a storage unit which is provided on one side of the main body to make possible storage and retrieval of a stored cable or peripheral device of the mobile terminal device.

9. The portable multifunctional mobile station of claim 1, further comprising:
one or more light emitting diode (LED) lighting units which are provided on one side of the main body; and
a lighting input unit that receives ON/OFF inputs provided by the LED lighting unit.

10. The portable multifunctional mobile station of claim 1, further comprising:
an outlet connector that is provided on one side of the main body, and is configure to provide power of the battery to an external device.
